(19) United States
(12) Patent Application Publication
(10) Pub. No.: US 2025/0102991 A1
(43) Pub. Date: Mar. 27, 2025

(54) IMAGE FORMING APPARATUS

(71) Applicant: FUJIFILM Business Innovation Corp., Tokyo (JP)

(72) Inventor: Kazuyoshi HAGIWARA, Kanagawa (JP)

(73) Assignee: FUJIFILM Business Innovation Corp., Tokyo (JP)

(21) Appl. No.: 18/438,903

(22) Filed: Feb. 12, 2024

(30) Foreign Application Priority Data
Sep. 22, 2023 (JP) 2023-158334

(51) Int. Cl. G03G 21/00

(52) U.S. Cl. CPC G03G 21/007; G03G 2221/0005; G03G 2221/0068

(57) ABSTRACT

An image forming apparatus includes: a moving portion that moves in one direction; an inclined surface that is disposed in a state of being inclined with respect to the one direction, has one end located on a side close to the moving portion and another end located on a side farther from the moving portion than the one end, and extends in a direction from the other end toward the one end; a cleaning member that is supported by the inclined surface, cleans the moving portion, and can change a disposition position in a normal extension direction, which is a direction in which a normal to the inclined surface extends; and a positioning portion that is used for positioning the cleaning member in a surface extension direction, which is the direction from the other end toward the one end, such that a disposition position of the cleaning member in the surface extension direction moves to a downstream side in the surface extension direction in response to a disposition position of the cleaning member being changed to a downstream side in the normal extension direction.

### CROSS-REFERENCE TO RELATED APPLICATIONS

This application is based on and claims priority under 35 USC 119 from Japanese Patent Application No. 2023-158334 filed Sep. 22, 2023.

### BACKGROUND

### (i) Technical Field

The present disclosure relates to an image forming apparatus.

### (ii) Related Art

Japanese Unexamined Patent Application Publication No. 2004-109587 discloses a cleaning device including a blade member, a vibration member to which the blade member is attached, and vibration applying means attached to the vibration member.

### SUMMARY

In an image forming apparatus, a cleaning member for cleaning a moving portion that moves is used to clean the moving portion.

When the position of the cleaning member is adjusted, the cleaning member may be displaced to the upstream side or downstream side in the moving direction of the moving portion along with the adjustment. When the cleaning member is displaced in the moving direction of the moving portion, there is a concern that a defect such as a decrease in cleaning performance of the cleaning member may occur.

Aspects of non-limiting embodiments of the present disclosure relate to making displacement of a cleaning member in a moving direction of a moving portion less likely to occur in association with adjustment of a position of the cleaning member, compared to a configuration in which, when the position of the cleaning member supported by an inclined surface disposed in a state of being inclined with respect to the moving direction of the moving portion is adjusted, the cleaning member does not move in an extending direction of the inclined surface.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a moving portion that moves in one direction, an inclined surface that is disposed in a state of being inclined with respect to the one direction, has one end located on a side close to the moving portion and another end located on a side farther from the moving portion than the one end, and extends in a direction from the other end toward the one end, a cleaning member that is supported by the inclined surface, cleans the moving portion, and can change a disposition position in a normal extension direction, which is a direction in which a normal to the inclined surface extends, and a positioning portion that is used for positioning the cleaning member in a surface extension direction, which is the direction from the other end toward the one end, such that a disposition position of the cleaning member in the surface extension direction moves to a downstream side in the surface extension direction in response to a disposition position of the cleaning member being changed to a downstream side in the normal extension direction.

### BRIEF DESCRIPTION OF THE DRAWINGS

An exemplary embodiment of the present invention will be described in detail based on the following figures, wherein:

FIG. 1 is a diagram for describing an image forming apparatus;

FIG. 2 is a cross-sectional view of a belt cleaner as viewed from the back side of the image forming apparatus;

FIG. 3 is a perspective view of one end portion of a cleaning member in the longitudinal direction, as viewed from the direction indicated by arrow III in FIG. 2;

FIG. 4 is a cross-sectional view of an interlocking member and the like taken along line IV-IV of FIG. 3;

FIG. 5 is a diagram illustrating another configuration example;

FIG. 6 is a diagram for describing a disposition member;

FIG. 7 is a diagram of a positioning portion as viewed from the direction indicated by arrow VII of FIG. 6; and

FIG. 8 is a diagram illustrating another configuration example of the belt cleaner.

### DETAILED DESCRIPTION

Hereinafter, an exemplary embodiment of the disclosure will be described in detail with reference to the drawings.

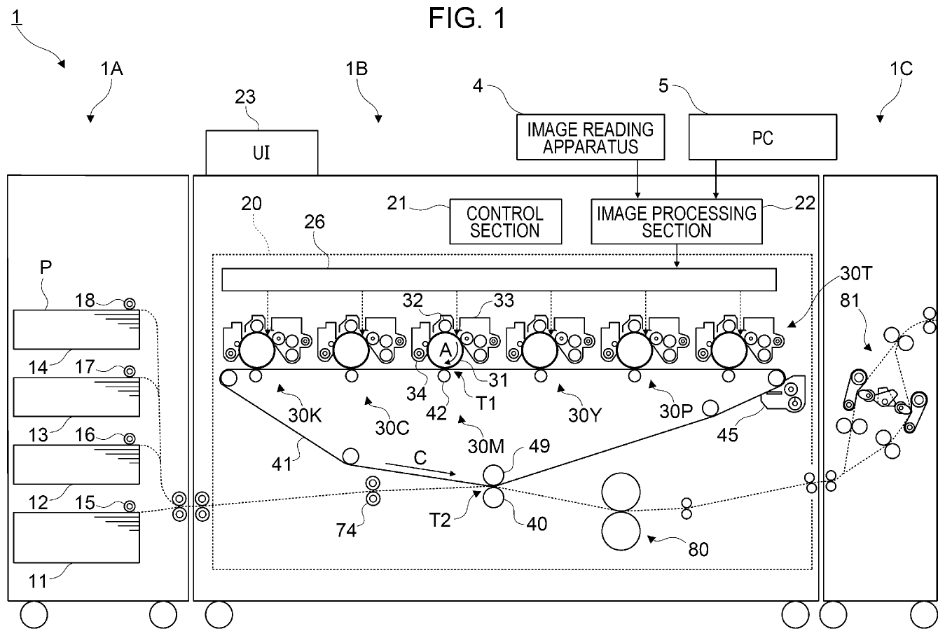

FIG. 1 is a diagram for describing an image forming apparatus 1. FIG. 1 illustrates a state where the image forming apparatus 1 is viewed from the front side.

The image forming apparatus 1 according to the exemplary embodiment includes a paper feeding unit 1A, a printing unit 1B, and a paper ejection unit 1C.

The paper feeding unit 1A includes a first paper container 11 to a fourth paper container 14 that contain paper P as an example of a recording medium.

The paper feeding unit 1A is further provided with feeding rollers 15 to 18 that are respectively provided for the first paper container 11 to the fourth paper container 14, and feed the paper P contained in the respective paper containers to a transport path connected to the printing unit 1B.

The printing unit 1B includes an image forming section 20 that forms an image on the paper P. The printing unit 1B is further provided with a control section 21 that controls each portion of the image forming apparatus 1.

The printing unit 1B further includes an image processing section 22. The image processing section 22 performs image processing for the image data transmitted from an image reading apparatus 4 and a personal computer (PC) 5.

The printing unit 1B is further provided with a user interface (UI) 23 including a touch panel and the like, notifies a user of information, and receives input of information from the user.

The image forming section 20 as an example of image forming means is provided with six image forming units 30T, 30P, 30Y, 30M, 30C, and 30K (hereinafter, the units may be simply referred to as “image forming units 30”) disposed in parallel at regular intervals.

Each image forming unit 30 includes a photoconductor drum 31 on which an electrostatic latent image is formed while rotating in the direction of arrow A, a charging roller 32 that charges the surface of the photoconductor drum 31, a developing device 33 that develops the electrostatic latent image formed on the photoconductor drum 31, and a drum cleaner 34 that removes toner and the like from the surface of the photoconductor drum 31.

The image forming section 20 is further provided with an exposure device 26 that exposes the photoconductor drum 31 of each image forming unit 30 to laser light.

The exposure of the photoconductor drum 31 by the exposure device 26 is not limited to the use of laser light. For example, a light source such as a light emitting diode (LED) may be provided for each image forming unit 30, and the photoconductor drum 31 may be exposed using light emitted from the light source.

The image forming units 30 are similarly configured, except for the toner stored in the respective developing devices 33. The image forming units 30Y, 30M, 30C, and 30K form yellow (Y), magenta (M), cyan (C), and black (K) toner images, respectively.

The image forming units 30T and 30P form toner images using toner corresponding to a corporate color, foaming toner for Braille, fluorescent color toner, toner for improving glossiness, or the like. In other words, the image forming units 30T and 30P form toner images using toner of spot colors.

The image forming section 20 is further provided with an intermediate transfer belt 41 to which the toner images of respective colors formed on the photoconductor drums 31 of the image forming units 30 are transferred.

The image forming section 20 is further provided with first transfer rollers 42 that transfer the toner images of respective colors of the image forming units 30 to the intermediate transfer belt 41 at respective first transfer parts T1.

The image forming section 20 is further provided with a second transfer roller 40 that collectively transfers the transferred toner images on the intermediate transfer belt 41 to the paper P at a second transfer part T2.

The image forming section 20 is further provided with a belt cleaner 45 that removes toner and the like from the surface of the intermediate transfer belt 41, and a fixing device 80 that fixes the secondarily-transferred image to the paper P.

The image forming section 20 performs an image forming operation on the basis of a control signal from the control section 21.

Specifically, in the image forming section 20, first, the image processing section 22 performs image processing on image data input from the image reading apparatus 4 and the PC 5, and the image data subjected to the image processing is supplied to the exposure device 26.

For example, in the magenta (M) image forming unit 30M, the surface of the photoconductor drum 31 is charged by the charging roller 32, and then laser light modulated with the image data obtained from the image processing section 22 is radiated to the photoconductor drum 31 by the exposure device 26.

Thus, an electrostatic latent image is formed on the photoconductor drum 31.

The formed electrostatic latent image is developed by the developing device 33, and a magenta toner image is formed on the photoconductor drum 31.

Similarly, yellow, cyan, and black toner images are formed in the image forming units 30Y, 30C, and 30K, and toner images of spot colors are formed in the image forming units 30T and 30P.

The toner images of respective colors formed in the image forming units 30 are sequentially electrostatically transferred by the first transfer rollers 42 to the intermediate transfer belt 41 rotating in the direction of arrow C in FIG. 1, and superimposed toner images are formed on the intermediate transfer belt 41.

The superimposed toner images formed on the intermediate transfer belt 41 are transported to the second transfer part T2 constituted by the second transfer roller 40 and a backup roller 49 with the movement of the intermediate transfer belt 41.

On the other hand, for example, the paper P is taken out from the first paper container 11 by the feeding roller 15, and then transported to the position of a resist roller 74 through the transport path.

When the superimposed toner images are transported to the second transfer part T2, the paper P is supplied from the resist roller 74 to the second transfer part T2 at that timing.

Then, at the second transfer part T2, the superimposed toner images are collectively electrostatically transferred to the paper P by the action of a transfer electric field formed between the second transfer roller 40 and the backup roller 49.

Thereafter, the paper P to which the superimposed toner images have been electrostatically transferred is transported to the fixing device 80.

In the fixing device 80, the paper P on which unfixed toner images are formed is pressed and heated, and processing of fixing the toner images to the paper P is performed.

Then, the paper P for which the fixing processing has been performed is transported to a paper stacking section (not illustrated) after passing through a curl correction section 81 provided in the paper ejection unit 1C.

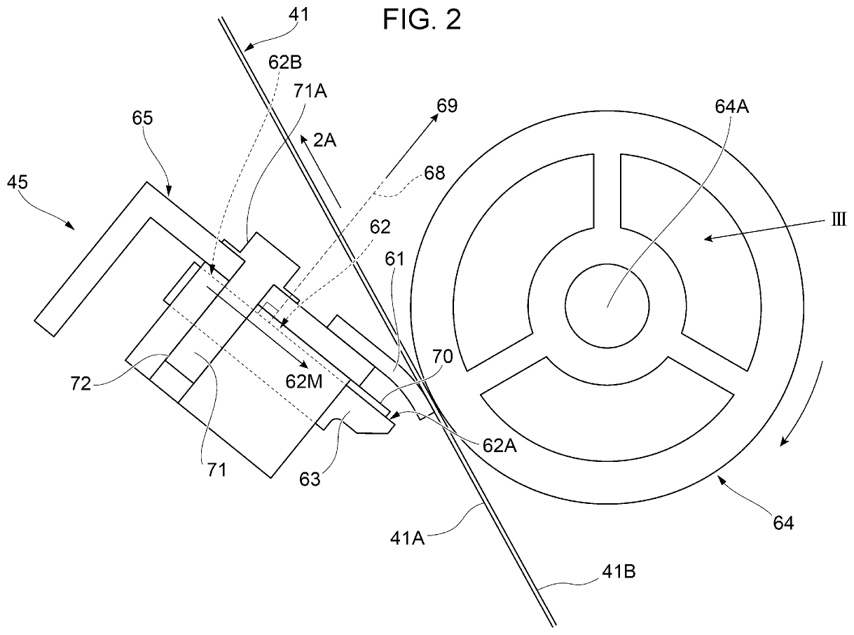

FIG. 2 is a cross-sectional view of the belt cleaner 45 as viewed from the back side of the image forming apparatus 1.

The belt cleaner 45 of the exemplary embodiment is provided with a cleaning member 61 for cleaning the intermediate transfer belt 41 that is an example of a moving portion.

The cleaning member 61 is constituted by a plate-like member. The cleaning member 61 is made of rubber and has elasticity.

In the exemplary embodiment, the intermediate transfer belt 41 moves in one direction 2A at a facing part of the belt cleaner 45.

The cleaning member 61 is disposed in contact with the intermediate transfer belt 41 moving in the one direction 2A, and cleans the intermediate transfer belt 41. More specifically, the cleaning member 61 is disposed in contact with an outer peripheral surface 41A of the intermediate transfer belt 41, and scrapes off and removes powder such as toner and paper dust adhering to the outer peripheral surface 41A.

The removed powder is transported by a transporting member (not illustrated) and moves to a powder container (not illustrated).

The belt cleaner 45 is further provided with an inclined surface 62 disposed in a state of being inclined with respect to the above-described one direction 2A, which is the moving direction of the intermediate transfer belt 41.

In the exemplary embodiment, a pedestal 63 that supports the cleaning member 61 is provided, and a surface of the pedestal 63 is the inclined surface 62.

In the exemplary embodiment, the cleaning member 61 is supported by the inclined surface 62. As described above, the inclined surface 62 is inclined with respect to the one direction 2A, which is the moving direction of the intermediate transfer belt 41.

As a result, in the exemplary embodiment, the cleaning member 61 supported by the inclined surface 62 is also disposed in a state of being inclined with respect to the one direction 2A. In other words, the cleaning member 61 is disposed at an angle with respect to the moving direction of the intermediate transfer belt 41.

The inclined surface 62 is disposed at a position facing the outer peripheral surface 41A of the intermediate transfer belt 41. The inclined surface 62 is disposed with a gap between the inclined surface 62 and the outer peripheral surface 41A of the intermediate transfer belt 41. The inclined surface 62 is a flat surface.

The inclined surface 62 has one end 62A located on a side close to the intermediate transfer belt 41, and another end 62B located on a side farther from the intermediate transfer belt 41 than the one end 62A.

The one end 62A and the other end 62B of the inclined surface 62 are different from each other in position in the moving direction of the intermediate transfer belt 41. The one end 62A of the inclined surface 62 is located on the upstream side in the moving direction of the intermediate transfer belt 41, and the other end 62B of the inclined surface 62 is located on the downstream side relative to the one end 62A in the moving direction of the intermediate transfer belt 41.

The inclined surface 62 is provided in the form of extending in a direction from the other end 62B toward the one end 62A. Hereinafter, in the present specification, the direction from the other end 62B toward the one end 62A is referred to as a “surface extension direction 62M”.

In the exemplary embodiment, a pressed member 64 against which the cleaning member 61 is pressed through the intermediate transfer belt 41 is provided at a position facing an inner peripheral surface 41B of the intermediate transfer belt 41.

The pressed member 64 is formed in a cylindrical shape, and is rotatable about a rotation shaft 64A along the width direction of the intermediate transfer belt 41.

The width direction of the intermediate transfer belt 41 is the same as the direction orthogonal to the one direction 2A, which is the moving direction of the intermediate transfer belt 41, and the pressed member 64 is rotatable about the rotation shaft 64A extending in the direction orthogonal to the moving direction of the intermediate transfer belt 41.

The pressed member 64 receives force from the inner peripheral surface 41B of the moving intermediate transfer belt 41 and rotates in the clockwise direction in the drawing.

The pressed member 64 supports, from the inner peripheral surface 41B side of the intermediate transfer belt 41, a part of the intermediate transfer belt 41 against which the cleaning member 61 is pressed.

In the exemplary embodiment, the cleaning member 61 is supported by the inclined surface 62.

More specifically, in the exemplary embodiment, the cleaning member 61 is attached to an interlocking member 65 as an example of an interlocking portion that moves in conjunction with the cleaning member 61, and in the exemplary embodiment, the cleaning member 61 is supported by the inclined surface 62 through the interlocking member 65.

For example, the interlocking member 65 is constituted by a metal plate. In the exemplary embodiment, the bending rigidity of the interlocking member 65 is greater than the bending rigidity of the cleaning member 61.

A configuration may be adopted in which the interlocking member 65 is not provided and the cleaning member 61 is directly supported by the inclined surface 62.

In the exemplary embodiment, the disposition position of the cleaning member 61 in a normal extension direction 69, which is a direction in which a normal 68 to the inclined surface 62 extends, can be changed.

In the exemplary embodiment, a disposition member 70 having a thickness can be disposed between the inclined surface 62 and the interlocking member 65, and the disposition position of the cleaning member 61 in the normal extension direction 69 is changed by disposing the disposition member 70 between the inclined surface 62 and the interlocking member 65.

In the exemplary embodiment, the disposition position of the cleaning member 61 in the normal extension direction 69 is changed by disposing the disposition member 70 on the inclined surface 62.

When the disposition member 70 is disposed between the interlocking member 65 and the inclined surface 62, the cleaning member 61 moves to the downstream side in the normal extension direction 69, and the disposition position of the cleaning member 61 in the normal extension direction 69 is changed.

In the exemplary embodiment, a fixing member 71 for fixing the interlocking member 65 to the pedestal 63 is provided. The fixing member 71 is a male screw and is fixed to a fixed portion 72 provided on the pedestal 63. The fixed portion 72 is constituted by a female screw.

In the exemplary embodiment, the interlocking member 65 is sandwiched between the pedestal 63 and a head portion 71A of the fixing member 71 constituted by a male screw, and thus the cleaning member 61 is fixed to the pedestal 63.

The fixing member 71 and the fixed portion 72 are disposed along the normal extension direction 69 in a relationship orthogonal to the inclined surface 62.

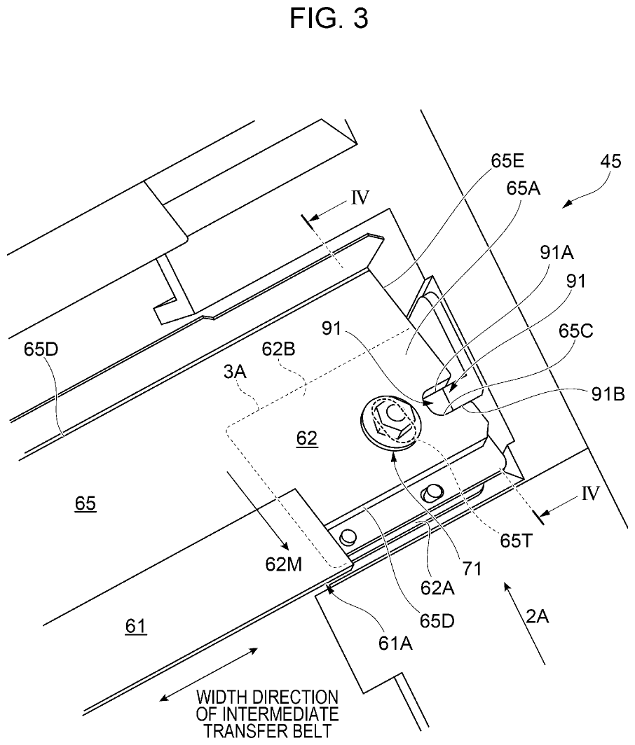

FIG. 3 is a perspective view of one end portion of the cleaning member 61 in the longitudinal direction, as viewed from the direction indicated by arrow III in FIG. 2. More specifically, FIG. 3 is a perspective view of one end portion of the cleaning member 61 illustrated in FIG. 2 located on the far side of the paper surface of FIG. 2.

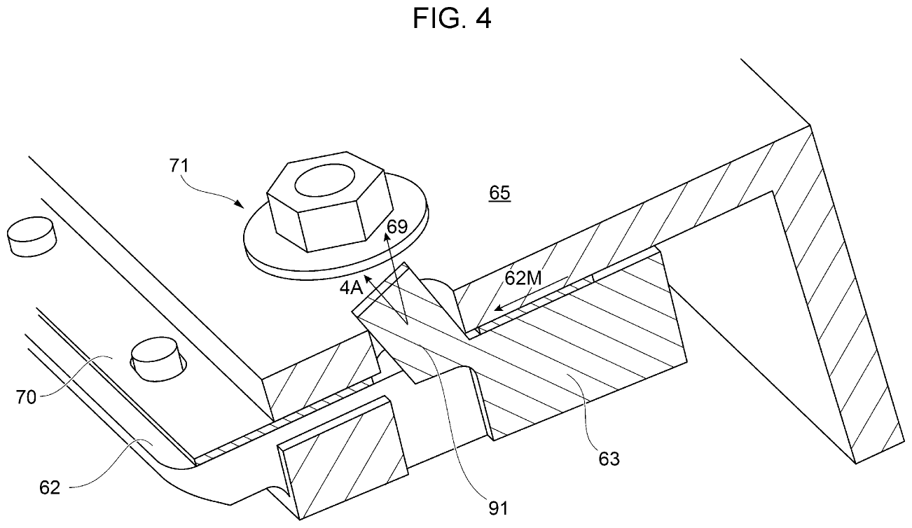

FIG. 4 is a cross-sectional view of the interlocking member 65 and the like taken along line IV-IV of FIG. 3.

FIG. 3 illustrates a state where one end portion 61A of the cleaning member 61 located on the front side of the image forming apparatus 1 is viewed.

The cleaning member 61 (see FIG. 3) is disposed along the width direction of the intermediate transfer belt 41, and has the one end portion 61A on one side in the width direction. In other words, the cleaning member 61 is disposed along the direction orthogonal to the one direction 2A, which is the moving direction of the intermediate transfer belt 41, and has the one end portion 61A on one side in the orthogonal direction.

The interlocking member 65 is also disposed along the width direction of the intermediate transfer belt 41, and has one end portion 65A on one side in the width direction. In other words, the interlocking member 65 is disposed along the direction orthogonal to the moving direction of the intermediate transfer belt 41, and has the one end portion 65A on one side in the orthogonal direction.

In the exemplary embodiment, the inclined surface 62 described above is disposed at a position facing the one end portion 65A of the interlocking member 65. In FIG. 3, the inclined surface 62 is provided inside a broken line 3A.

In FIG. 3, illustration of the intermediate transfer belt 41 is omitted. In FIG. 3, the one end portion 61A of the cleaning member 61 in the longitudinal direction and the one end portion 65A of the interlocking member 65 in the longitudinal direction are described, but the other end portions of the cleaning member 61 and the interlocking member 65 in the longitudinal direction have a configuration similar to that of the one end portions.

In the exemplary embodiment, as illustrated in FIG. 3, a positioning portion 91 for positioning the cleaning member 61 is provided. The positioning portion 91 is used for positioning the cleaning member 61 in the surface extension direction 62M, which is the direction from the other end 62B toward the one end 62A of the inclined surface 62.

In the exemplary embodiment, as illustrated in FIG. 4, the positioning portion 91 is constituted by a protruding portion extending in a direction indicated by arrow 4A in the drawing.

The positioning portion 91 illustrated in FIG. 4 is formed in a linear shape, and is disposed in a state of being inclined with respect to the normal extension direction 69. The positioning portion 91 is inclined with respect to the normal extension direction 69 to extend toward the downstream side in the surface extension direction 62M as positioning portion 91 extends toward the downstream side in the normal extension direction 69.

In the exemplary embodiment, since the positioning portion 91 illustrated in FIG. 4 is provided, in response to a change of the disposition position of the cleaning member 61 (not illustrated in FIG. 4) to the downstream side in the normal extension direction 69, the disposition position of the cleaning member 61 in the surface extension direction 62M moves to the downstream side in the surface extension direction 62M.

FIG. 4 illustrates a state in which the disposition member 70 is disposed on the inclined surface 62.

In the exemplary embodiment, when the disposition position of the cleaning member 61 is changed to the downstream side in the normal extension direction 69 by the disposition member 70 placed on the inclined surface 62, the interlocking member 65 is guided by the positioning portion 91 in the inclined state and moves to the downstream side in the surface extension direction 62M.

In the exemplary embodiment, as illustrated in FIG. 3, the interlocking member 65 is provided with a recessed portion 65C into which the positioning portion 91 is inserted.

In the exemplary embodiment, the interlocking member 65 is formed in a rectangular shape. The interlocking member 65 has two long sides 65D extending parallel to each other along the width direction of the intermediate transfer belt 41, and two short sides 65E orthogonal to the long sides 65D and parallel to each other. FIG. 3 illustrates only one short side 65E of the two short sides 65E.

The recessed portion 65C is provided on one short side 65E of the interlocking member 65. The recessed portion 65C is recessed from the one short side 65E toward the other short side 65E (not illustrated).

In the exemplary embodiment, the movement of the cleaning member 61 to the downstream side and the upstream side in the surface extension direction 62M is restricted by the positioning portion 91.

In the exemplary embodiment, when the cleaning member 61 attempts to move to the downstream side or upstream side in the surface extension direction 62M, the interlocking member 65 abuts against the positioning portion 91 that has been inserted into the recessed portion 65C, and the movement of the cleaning member 61 is restricted.

When the cleaning member 61 attempts to move to the downstream side in the surface extension direction 62M, the interlocking member 65 abuts against one side 91A of the positioning portion 91.

When the cleaning member 61 attempts to move to the upstream side in the surface extension direction 62M, the interlocking member 65 abuts against another side 91B of the positioning portion 91.

Thus, the movement of the interlocking member 65 to the downstream side and the upstream side in the surface extension direction 62M is restricted, and accordingly, the movement of the cleaning member 61 to the downstream side and the upstream side in the surface extension direction 62M is restricted.

In the exemplary embodiment, an example in which the recessed portion 65C is formed in the interlocking member 65 is described, but other cases may be considered without being limited to this example. For example, a through hole along the thickness direction of the interlocking member 65 may be formed in the interlocking member 65. A configuration may be adopted in which the rod-like positioning portion 91 (not illustrated) disposed in a state of being inclined with respect to the normal extension direction 69 (see FIG. 4) passes through the through hole.

In the case where the interlocking member 65 is omitted and the cleaning member 61 is directly placed on the inclined surface 62, the recessed portion 65C or a through hole may be formed in the cleaning member 61.

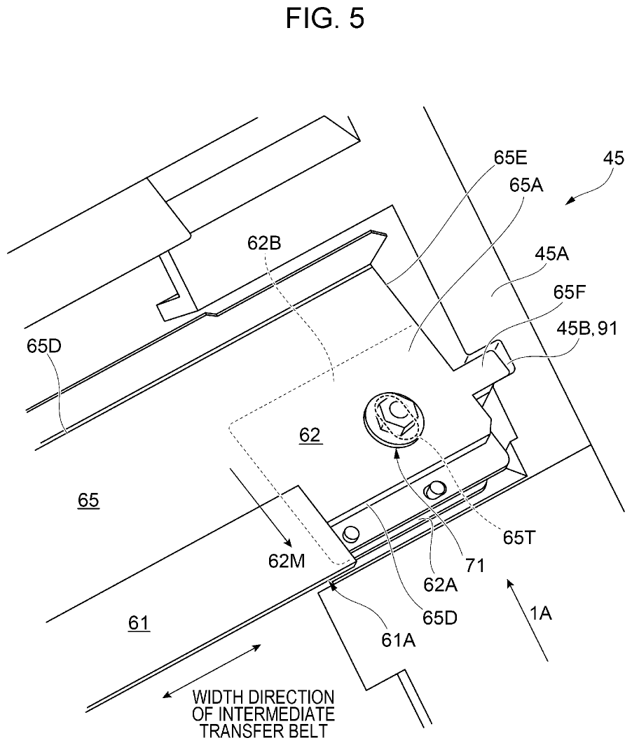

FIG. 5 is a diagram illustrating another configuration example.

Alternatively, for example, as illustrated in FIG. 5, a protrusion portion 65F protruding in a direction away from the interlocking member 65 may be provided on the short side 65E of the interlocking member 65, and a positioning portion 91 constituted by a recessed portion 45B into which the protrusion portion 65F is inserted may be provided on the main body 45A side of the belt cleaner 45.

In this configuration example, the movement of the cleaning member 61 to the downstream side and the upstream side in the surface extension direction 62M is restricted by the protrusion portion 65F abutting against the inner surface of the positioning portion 91 formed in a recessed shape.

Also in the case where the recessed positioning portion 91 is provided, similarly to the positioning portion 91 illustrated in FIGS. 3 and 4, the recessed positioning portion 91 is provided in a state of being inclined with respect to the normal extension direction 69 (see FIG. 4).

More specifically, the recessed positioning portion 91 is inclined with respect to the normal extension direction 69 to extend toward the downstream side in the surface extension direction 62M as the recessed positioning portion 91 extends toward the downstream side in the normal extension direction 69.

In the case where the interlocking member 65 is omitted and the cleaning member 61 is directly placed on the inclined surface 62, the protrusion portion 65F is provided in the cleaning member 61.

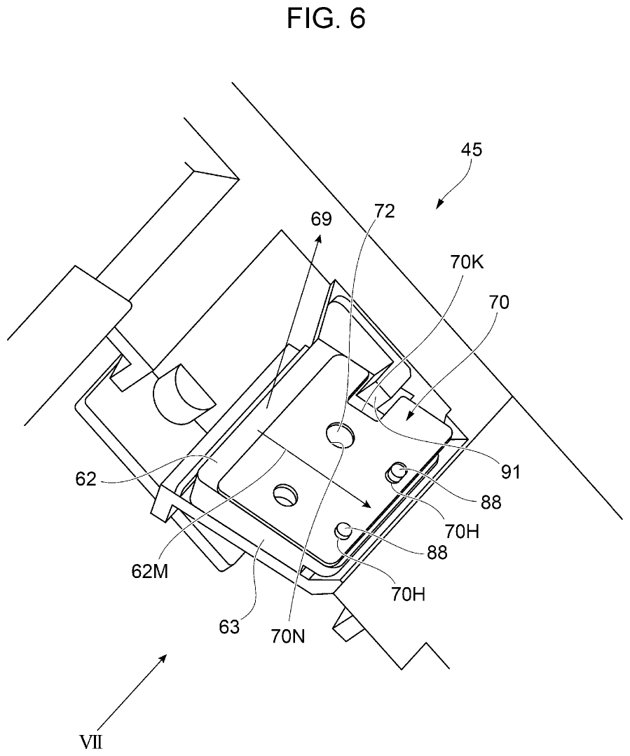

FIG. 6 is a diagram for describing the disposition member 70. FIG. 6 illustrates a state of the pedestal 63 in a state where the cleaning member 61 and the interlocking member 65 are removed.

In the exemplary embodiment, when the disposition position of the cleaning member 61 (not illustrated in FIG. 6) is changed to the downstream side in the normal extension direction 69, the plate-like disposition member 70 is disposed between the inclined surface 62 and the interlocking member 65 (see FIG. 3), as illustrated in FIG. 6.

In the exemplary embodiment, the disposition member 70 is disposed in a state of being placed on the inclined surface 62. In the exemplary embodiment, the interlocking member 65 to which the cleaning member 61 is attached is placed on the disposition member 70 placed on the inclined surface 62.

In the exemplary embodiment, when the disposition position of the cleaning member 61 in the normal extension direction 69 is changed, the number of disposition members 70 to be placed is increased or decreased, and/or the disposition member 70 to be placed on the inclined surface 62 is changed to another disposition member 70 having a different thickness.

Thus, the disposition position of the cleaning member 61 in the normal extension direction 69 changes. When the disposition position of the cleaning member 61 in the normal extension direction 69 changes, the contact pressure between the intermediate transfer belt 41 (see FIG. 2) and the cleaning member 61 changes, and the cleaning performance changes.

In the case where the interlocking member 65 is not provided and the cleaning member 61 is directly placed on the inclined surface 62, the disposition member 70 is disposed between the cleaning member 61 and the inclined surface 62.

The inclined surface 62 (see FIG. 6) is provided with a restriction portion 88 that restricts movement of the disposition member 70 in an extension direction of the inclined surface 62. The “extension direction” includes both the surface extension direction 62M and the direction orthogonal to the surface extension direction 62M.

The restriction portion 88 is constituted by a protruding portion protruding from the inclined surface 62. The movement of the disposition member 70 is restricted by the protruding portion being inserted into a through hole 70H formed in the disposition member 70.

In the exemplary embodiment, the inclined surface 62 is inclined with respect to the horizontal direction, and the disposition member 70 placed on the inclined surface 62 easily moves. By providing the restriction portion 88, the movement of the disposition member 70 relative to the inclined surface 62 is restricted.

The manner in which the movement of the disposition member 70 is restricted by the restriction portion 88 is not limited to the manner illustrated in FIG. 6. A protruding portion may be provided in the disposition member 70 and a recessed portion into which the protruding portion is inserted may be provided in the inclined surface 62.

In FIG. 6, the through hole 70H is provided in the disposition member 70 and the restriction portion 88 formed by a protruding portion is inserted into the through hole 70H, but a portion of the disposition member 70 where the restriction portion 88 is inserted may be, instead of the through hole 70H, a recessed portion recessed from the surface of the disposition member 70 toward the inside of the disposition member 70.

Alternatively, for example, a configuration may be adopted in which protrusions are provided on both the inclined surface 62 and the disposition member 70, and the protrusions are caught by each other to restrict the movement of the disposition member 70.

In the exemplary embodiment, as illustrated in FIG. 6, the disposition member 70 is provided with a screw through hole 70N through which the above-described fixing member 71 (see FIG. 3) constituted by a male screw passes.

Below the screw through hole 70N is provided the fixed portion 72 formed by a female screw formed on the pedestal 63.

The disposition member 70 is provided with a recessed portion 70K for avoiding interference between the disposition member 70 and the positioning portion 91, and the positioning portion 91 is inside the recessed portion 70K.

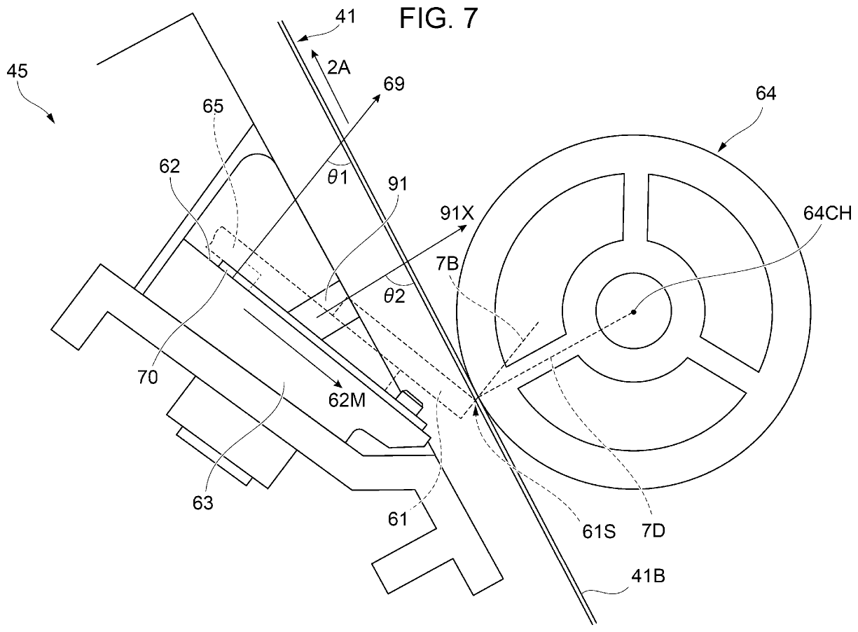

FIG. 7 is a diagram of the positioning portion 91 as viewed from the direction indicated by arrow VII of FIG. 6.

In the exemplary embodiment, an angle θ2 formed by an extension direction 91X of the positioning portion 91 formed in a linear shape and the one direction 2A, which is the direction in which the intermediate transfer belt 41 moves, is larger than an angle θ1 formed by the one direction 2A and the normal extension direction 69.

In the exemplary embodiment, the angle θ2 formed by the extension direction 91X of the positioning portion 91 and the one direction 2A is substantially 90°, and the extension direction 91X of the positioning portion 91 and the one direction 2A are in a relationship of being substantially orthogonal to each other.

In the exemplary embodiment, when there are two angles of an obtuse angle and an acute angle, the “angleθ1 formed” and the “angle θ2 formed” refer to the acute angle.

In the exemplary embodiment, there are two angles of an obtuse angle and an acute angle as angles formed by the normal extension direction 69 and the one direction 2A, which is the direction in which the intermediate transfer belt 41 moves. In the exemplary embodiment, as described above, the “angle formed” refers to the acute angle, and in this case, the angle θ1 formed described above refers to the acute angle.

In the exemplary embodiment, when the cleaning member 61 is moved to the downstream side in the normal extension direction 69 from the state illustrated in FIG. 7, the interlocking member 65 is guided by the positioning portion 91, and the cleaning member 61 moves to the downstream side in the surface extension direction 62M while moving to the downstream side in the normal extension direction.

In the exemplary embodiment, in a case where a user wants to change the cleaning performance, as described above, the user increases or decreases the number of the disposition members 70 to be placed and/or changes the disposition member 70 to be placed on the inclined surface 62 to another disposition member 70 having a different thickness.

Thus, the cleaning member 61 moves to the upstream side or downstream side in the normal extension direction 69. At this time, the cleaning member 61 moves to the downstream side or upstream side in the surface extension direction 62M.

When the cleaning member 61 moves to the upstream side or downstream side in the normal extension direction 69, the degree of pressing of the cleaning member 61 against the intermediate transfer belt 41 changes, and the cleaning performance of the cleaning member 61 changes.

A case is assumed in which the positioning portion 91 is not provided.

In this case, a tip portion 61S of the cleaning member 61 moves along the normal extension direction 69, and thus moves along a path 7B.

In this case, the contact position between the cleaning member 61 and the intermediate transfer belt 41 moves to the upstream side or downstream side in the moving direction of the intermediate transfer belt 41. In this case, an unintended change in cleaning performance may be caused.

In the exemplary embodiment, the cylindrical pressed member 64 is provided on the inner peripheral surface 41B side of the intermediate transfer belt 41. In the exemplary embodiment, when the contact position between the cleaning member 61 and the intermediate transfer belt 41 moves to the upstream side or downstream side in the moving direction of the intermediate transfer belt 41, the posture of the cleaning member 61 relative to the pressed member 64 changes.

In this case, the change in posture may cause an unintended change in cleaning performance.

However, in the exemplary embodiment, for example, even when the disposition position of the cleaning member 61 changes to the downstream side in the normal extension direction 69, the interlocking member 65 is guided by the positioning portion 91, and the tip portion 61S of the cleaning member 61 moves along the line indicated by reference sign 7D.

The line indicated by reference sign 7D is a line extending along the direction orthogonal to the one direction 2A, which is the moving direction of the intermediate transfer belt 41, and the tip portion 61S of the cleaning member 61 moves in the direction orthogonal to the moving direction of the intermediate transfer belt 41.

In the exemplary embodiment, the tip portion 61S of the cleaning member 61 moves toward a rotation center 64CH of the pressed member 64.

In the exemplary embodiment, in response to the disposition position of the cleaning member 61 being changed to the downstream side in the normal extension direction 69, the disposition position of the cleaning member 61 in the surface extension direction 62M moves to the downstream side in the surface extension direction 62M.

In this case, compared to a case where the disposition position of the cleaning member 61 does not move to the downstream side in the surface extension direction 62M, the posture of the cleaning member 61 relative to the pressed member 64 is less likely to change, and an unintended change in cleaning performance is less likely to occur.

In the exemplary embodiment, also in the case where the cleaning member 61 is directly placed on the inclined surface 62, the cleaning member 61 is guided by the positioning portion 91. Also in this case, the posture of the cleaning member 61 relative to the pressed member 64 is less likely to change, and an unintended change in cleaning performance is less likely to occur.

Although description is omitted above, in the exemplary embodiment, as illustrated in FIG. 3, a hole 65T through which the fixing member 71 passes is formed in the interlocking member 65. As described above, in the exemplary embodiment, the fixing member 71 fixes the cleaning member 61 to the inclined surface 62.

The hole 65T formed in the interlocking member 65 is an elongated hole. The elongated hole 65T extends in the surface extension direction 62M.

Thus, as in the exemplary embodiment, even in a configuration in which the interlocking member 65 moves to the downstream side or upstream side in the surface extension direction 62M, interference between the fixing member 71 and the interlocking member 65 does not occur.

Also in the case where the cleaning member 61 is directly placed on the inclined surface 62, the hole formed in the cleaning member 61 through which the fixing member 71 passes is formed as an elongated hole, so that interference between the fixing member 71 and the cleaning member 61 does not occur.

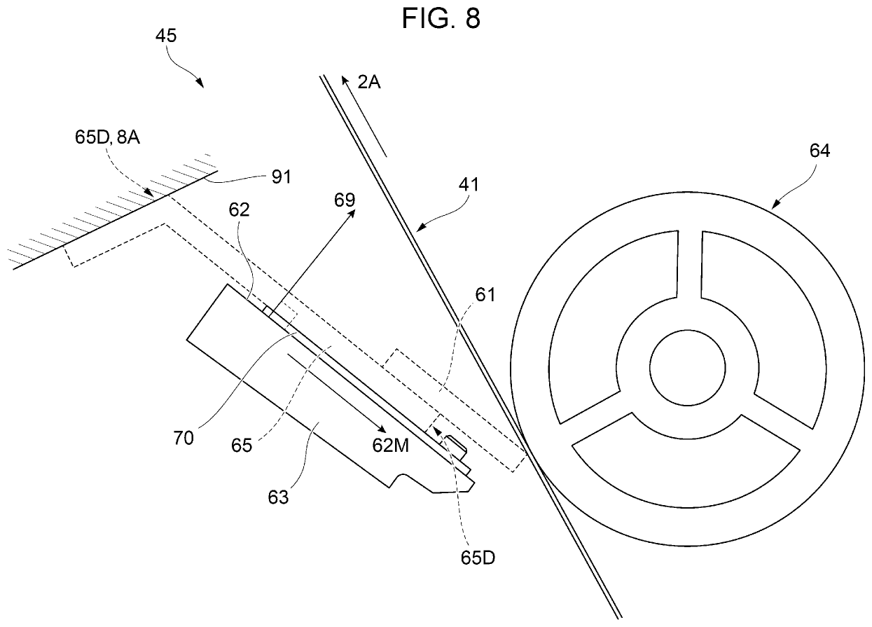

FIG. 8 is a diagram illustrating another configuration example of the belt cleaner 45.

Although the configuration in which the positioning portion 91 comes into contact with the portion provided with the short side 65E located at the one end portion 65A of the interlocking member 65 in the longitudinal direction (see FIG. 3) has been described above, the cleaning member 61 may be positioned in the surface extension direction 62M by bringing the positioning portion 91 into contact with a different portion of the interlocking member 65.

In the configuration example illustrated in FIG. 8, one long side 65D indicated by reference sign 8A of the two long sides 65D of the interlocking member 65 comes into contact with the positioning portion 91.

More specifically, of the two long sides 65D of the interlocking member 65, the long side 65D located on the downstream side in the one direction 2A, which is the moving direction of the intermediate transfer belt 41, comes into contact with the positioning portion 91 extending along the width direction of the intermediate transfer belt 41.

The positioning portion 91 is formed in a planar shape. The positioning portion 91 is disposed in a state of being inclined with respect to the normal extension direction 69 in a manner similar to that described above.

Also in this configuration example, even when the disposition position of the cleaning member 61 is changed to the downstream side in the normal extension direction 69, the positioning portion 91 causes the cleaning member 61 to move to the downstream side in the surface extension direction 62M.

Thus, also in this case, the posture of the cleaning member 61 relative to the pressed member 64 is less likely to change, and an unintended change in cleaning performance is less likely to occur.

The above-described configuration may be provided at a portion other than the belt cleaner 45.

For example, the above-described configuration may be provided in the drum cleaner 34 (see FIG. 1) or the fixing device 80. Although the configuration in which the cleaning member 61 comes into contact with the intermediate transfer belt 41 as an example of the moving portion has been described above, the outer peripheral surface of the photoconductor drum 31, the outer peripheral surface of a belt provided in the fixing device 80, and the like are also exemplified as targets to be cleaned.

In providing the cleaning member 61 that cleans the outer peripheral surface of the photoconductor drum 31 or the outer peripheral surface of the belt provided in the fixing device 80, providing the above-described positioning portion 91 makes it less likely that an unintended change in cleaning performance occurs, similarly to the above.

### Appendix

(((1)))

An image forming apparatus comprising:
a moving portion that moves in one direction;
an inclined surface that is disposed in a state of being inclined with respect to the one direction, has one end located on a side close to the moving portion and another end located on a side farther from the moving portion than the one end, and extends in a direction from the other end toward the one end;
a cleaning member that is supported by the inclined surface, cleans the moving portion, and can change a disposition position in a normal extension direction, which is a direction in which a normal to the inclined surface extends; and
a positioning portion that is used for positioning the cleaning member in a surface extension direction, which is the direction from the other end toward the one end, such that a disposition position of the cleaning member in the surface extension direction moves to a downstream side in the surface extension direction in response to a disposition position of the cleaning member being changed to a downstream side in the normal extension direction.
   (((2)))

The image forming apparatus according to (((1))), wherein the positioning portion is formed in a linear shape, and is disposed in a state of being inclined with respect to the normal extension direction to extend toward a downstream side in the surface extension direction as the positioning portion extends toward a downstream side in the normal extension direction.

(((3)))

The image forming apparatus according to (((2))), wherein an angle formed by an extension direction of the positioning portion formed in a linear shape and the one direction, which is a direction in which the moving portion moves, is larger than an angle formed by the one direction and the normal extension direction.

(((4)))

The image forming apparatus according to (((1))), wherein movement of the cleaning member to a downstream side and an upstream side in the surface extension direction is restricted by the positioning portion.

(((5)))

The image forming apparatus according to (((4))), wherein a recessed portion or through hole into which the positioning portion is inserted is formed in the cleaning member or an interlocking portion that moves in conjunction with the cleaning member, and movement of the cleaning member to the downstream side and the upstream side is restricted by the cleaning member or the interlocking portion abutting against the positioning portion that has been inserted into the recessed portion or through hole.

(((6)))

The image forming apparatus according to (((4))), wherein a protrusion portion to be inserted into the positioning portion formed in a recessed shape is provided in the cleaning member or an interlocking portion that moves in conjunction with the cleaning member, and movement of the cleaning member to the downstream side and the upstream side is restricted by the protrusion portion abutting against an inner surface of the positioning portion formed in a recessed shape.

(((7)))

The image forming apparatus according to (((1))), wherein when the cleaning member is moved to a downstream side in the normal extension direction, the cleaning member moves to the downstream side while the cleaning member or an interlocking portion that moves in conjunction with the cleaning member is guided by the positioning portion.

(((8)))

The image forming apparatus according to (((1))), wherein when a disposition position of the cleaning member is changed to a downstream side in the normal extension direction, a disposition member is disposed between the cleaning member or an interlocking portion that moves in conjunction with the cleaning member and the inclined surface, and the inclined surface is provided with a restriction portion that restricts movement of the disposition member in an extension direction of the inclined surface.

(((9)))

The image forming apparatus according to (((1))), wherein a hole through which a fixing member used for fixing the cleaning member to the inclined surface passes, is formed in the cleaning member or an interlocking portion that moves in conjunction with the cleaning member, and the hole is an elongated hole and extends in the surface extension direction.

What is claimed is:

1. An image forming apparatus comprising:
a moving portion that moves in one direction;
an inclined surface that is disposed in a state of being inclined with respect to the one direction, has one end located on a side close to the moving portion and another end located on a side farther from the moving portion than the one end, and extends in a direction from the other end toward the one end;
a cleaning member that is supported by the inclined surface, cleans the moving portion, and can change a disposition position in a normal extension direction, which is a direction in which a normal to the inclined surface extends; and
a positioning portion that is used for positioning the cleaning member in a surface extension direction, which is the direction from the other end toward the one end, such that a disposition position of the cleaning member in the surface extension direction moves to a downstream side in the surface extension direction in response to a disposition position of the cleaning member being changed to a downstream side in the normal extension direction.

2. The image forming apparatus according to claim 1, wherein
the positioning portion is formed in a linear shape, and is disposed in a state of being inclined with respect to the normal extension direction to extend toward a downstream side in the surface extension direction as the positioning portion extends toward a downstream side in the normal extension direction.

3. The image forming apparatus according to claim 2, wherein
an angle formed by an extension direction of the positioning portion formed in a linear shape and the one direction, which is a direction in which the moving portion moves, is larger than an angle formed by the one direction and the normal extension direction.

4. The image forming apparatus according to claim 1, wherein
movement of the cleaning member to a downstream side and an upstream side in the surface extension direction is restricted by the positioning portion.

5. The image forming apparatus according to claim 4, wherein
a recessed portion or through hole into which the positioning portion is inserted is formed in the cleaning member or an interlocking portion that moves in conjunction with the cleaning member, and movement of the cleaning member to the downstream side and the upstream side is restricted by the cleaning member or the interlocking portion abutting against the positioning portion that has been inserted into the recessed portion or through hole.

6. The image forming apparatus according to claim 4, wherein
a protrusion portion to be inserted into the positioning portion formed in a recessed shape is provided in the cleaning member or an interlocking portion that moves in conjunction with the cleaning member, and movement of the cleaning member to the downstream side and the upstream side is restricted by the protrusion portion abutting against an inner surface of the positioning portion formed in a recessed shape.

7. The image forming apparatus according to claim 1, wherein
when the cleaning member is moved to a downstream side in the normal extension direction, the cleaning member moves to the downstream side while the cleaning member or an interlocking portion that moves in conjunction with the cleaning member is guided by the positioning portion.

8. The image forming apparatus according to claim 1, wherein
when a disposition position of the cleaning member is changed to a downstream side in the normal extension direction, a disposition member is disposed between the cleaning member or an interlocking portion that moves in conjunction with the cleaning member and the inclined surface, and the inclined surface is provided with a restriction portion that restricts movement of the disposition member in an extension direction of the inclined surface.

9. The image forming apparatus according to claim 1, wherein
a hole through which a fixing member used for fixing the cleaning member to the inclined surface passes, is formed in the cleaning member or an interlocking portion that moves in conjunction with the cleaning member, and the hole is an elongated hole and extends in the surface extension direction.
